(19) United States
(12) Patent Application Publication
(10) Pub. No.: US 2019/0204847 A1
(43) Pub. Date: Jul. 4, 2019

(54) MOVING APPARATUS FOR CLEANING AND METHOD OF CONTROLLING THE SAME

(71) Applicant: Samsung Electronics Co., Ltd., Suwon-si (KR)

(72) Inventors: Taegyoon NOH, Suwon-si (KR); Junhoe CHOI, Suwon-si (KR); Seoho LEE, Suwon-si (KR); Jeongsu HAN, Suwon-si (KR)

(73) Assignee: Samsung Electronics Co., Ltd., Suwon-si (KR)

(21) Appl. No.: 16/232,211

(22) Filed: Dec. 26, 2018

(30) Foreign Application Priority Data
Dec. 29, 2017 (KR) 10-2017-0183747

(51) Int. Cl. G05D 1/02; G01S 13/93; A47L 9/00; A47L 9/28

(52) U.S. Cl. CPC G05D 1/0257; G01S 13/931; G05D 1/0214; A47L 9/009; G05D 1/0088; A47L 9/2852; G05D 2201/0203; A47L 2201/04; A47L 9/2826

(57) ABSTRACT

A moving apparatus for cleaning includes: a cleaner configured to perform cleaning; a traveler configured to move the moving apparatus; a sensor including a transmitter configured to transmit a radio frequency (RF) signal toward a front floor, and a receiver configured to receive a reflection signal of the RF signal; and a processor configured to control the traveler to make the moving apparatus travel corresponding to a result of determining that an obstacle is present in the front floor based on a signal pattern detected from the received reflection signal. Thus, the cleaning robot is provided with a radar sensing function using the RF signal, and thus improved in accuracy of detecting an obstacle without being affected by surrounding color, light disturbance and the like environment.

### CROSS-REFERENCE TO RELATED APPLICATIONS

This application is based on and claims priority under 35 U.S.C. § 119 to Korean Patent Application No. 10-2017-0183747 filed on Dec. 29, 2017 in the Korean Intellectual Property Office, the disclosure of which is incorporated by reference herein in its entirety.

### BACKGROUND

### 1. Field

The present disclosure relates to a moving apparatus for cleaning and a method of controlling the moving apparatus, and more particularly, to a moving apparatus for autonomously moving and cleaning a floor and a method of controlling the moving apparatus.

### 2. Description of the Related Art

A cleaning robot and a related moving apparatus for cleaning refers to an electronic apparatus that includes a cleaning module for cleaning a surface such as a floor at home, and a moving module for moving on the surface, and moves and cleans the surface autonomously.

The cleaning robot needs to be controlled to move while avoiding a collision with an obstacle on a traveling path while the cleaning robot is moving and cleaning the floor.

To avoid the collision between the cleaning robot and the obstacle, a structure for sensing the obstacle through an infrared signal has been proposed. Specifically, the cleaning robot emits an infrared signal and detects the presence of the obstacle on the basis of a reflected infrared signal.

However, the infrared signal is easily likely to be affected by sunlight and a similar light disturbance, and has problems that its sensing rate decreases as the color of the obstacle becomes darker and the infrared signal cannot detect liquids and similar obstacles. Therefore, accuracy in detecting the obstacle may be lowered by a color of a place to be cleaned, sunlight or other light disturbances, external noise, temperature, etc., and a contamination of a liquid obstacle may be spread out.

### SUMMARY

According to an embodiment of the present disclosure, there is provided a moving apparatus for cleaning, which is unaffected by external environments and is capable of detecting various obstacles such as liquids with high accuracy, and a control method thereof.

Further, the present disclosure provides a moving apparatus for cleaning, of which traveling and cleaning operations are properly performed corresponding to the kind of detected obstacle, and a method of controlling the same.

According to an embodiment, a moving apparatus for cleaning includes a cleaner configured to perform cleaning; a traveler configured to move the moving apparatus; a sensor including a transmitter configured to transmit a radio frequency (RF) signal toward a front floor, and a receiver configured to receive a reflection signal of the RF signal; and a processor configured to control the traveler to make the moving apparatus travel corresponding to a result of determining that an obstacle is present in the front floor based on a signal pattern detected from the received reflection signal. Thus, the cleaning robot is provided with a radar sensing function using the RF signal, and thus improved in accuracy of detecting an obstacle without being affected by surrounding color, light disturbance and the like environment.

When the signal pattern shows change in amplitude or phase greater than or equal to a preset value, the processor may determine that the obstacle present at a position where the change is made is liquid. The processor may control the traveler to make the moving apparatus travel avoiding the obstacle. Thus, water and the like liquid are easily detected as an obstacle, so that the cleaning robot can travel properly avoiding the obstacle.

The processor may determine a horizontal distance between the moving apparatus and the obstacle based on information about time taken from transmission of the RF signal to reception of the reflection signal, and may control the traveler to make the moving apparatus travel according to the determined horizontal distance. The processor may control the traveler to make the moving apparatus travel backward, turn and travel avoiding the obstacle when the determined horizontal distance is shorter than a reference distance. Thus, the control is made to perform proper avoiding travel according to distances from the obstacle.

The processor may determine a line between two floors different in quality of a material, when the signal pattern includes a plurality of pulses generated leaving an interval shorter than a preset time. When the signal pattern includes the plurality of pulses, the processor may determine that the obstacle is a carpet, and controls outputs of the traveler and the cleaner. Thus, it is possible to not only easily detect the carpet laid on the floor by the radar sensing function, but also control traveling and cleaning operations suitable for the carpet.

When the signal pattern shows that a vertical distance from the floor is longer than or equal to a reference distance, the processor may determine that a recess zone is present in the floor. The processor may determine the vertical distance based on time taken from transmission of the RF signal to reception of the reflection signal, and the reference distance may correspond to a sum of a height of the sensor from the floor and a preset fall height. Thus, the radar sensing function is used to detect a recessed zone such as the recess in the floor, thereby preventing the cleaning robot from falling over the recess.

The sensor may be installed to have a preset orientation angle to the floor in front of the moving apparatus. The sensor may be provided in plural, and the plurality of sensors may be arranged to make areas respectively covered by the plurality of sensors be partially overlapped. Thus, the detection is performed without missing any area in front of the cleaning robot.

According to an embodiment, a method of controlling a moving apparatus for cleaning includes: by a sensor, transmitting a radio frequency (RF) signal toward a front floor; by the sensor, receiving a reflection signal of the RF signal; determining whether an obstacle is present in the front floor based on a signal pattern detected from the received reflection signal; and controlling an operation of the moving apparatus according to results of the determination. Thus, the cleaning robot is provided with a radar sensing function using the RF signal, and thus improved in accuracy of detecting an obstacle without being affected by surrounding color, light disturbance and the like environment.

The method may further include determining that the obstacle present at a position where change in amplitude or phase greater than or equal to a preset value is made is liquid, when the signal pattern shows the change. The method may further include controlling the moving apparatus to travel avoiding the obstacle according to the determination results. Thus, water and the like liquid are easily detected as an obstacle, so that the cleaning robot can travel properly avoiding the obstacle.

The method may further include: determining a horizontal distance between the moving apparatus and the obstacle based on information about time taken from transmission of the RF signal to reception of the reflection signal; and controlling the moving apparatus to travel according to the determined horizontal distance. The controlling the moving apparatus to travel may include making the moving apparatus travel backward, turn and travel avoiding the obstacle when the determined horizontal distance is shorter than a reference distance. Thus, the control is made to perform proper avoiding travel according to distances from the obstacle.

The method may further include determining a line between two floors different in quality of a material, when the signal pattern includes a plurality of pulses generated leaving an interval shorter than a preset time. The method may further include: determining that the obstacle is a carpet when the signal pattern includes the plurality of pulses; and controlling the moving apparatus to travel and clean according to the determination results. Thus, it is possible to not only easily detect the carpet laid on the floor by the radar sensing function, but also control traveling and cleaning operations suitable for the carpet.

The method may further include determining that a recess zone is present in the floor, when the signal pattern shows that a vertical distance from the floor is longer than or equal to a reference distance. The method may further include determining the vertical distance based on time taken from transmission of the RF signal to reception of the reflection signal, and the reference distance may correspond to a sum of a height of the sensor from the floor and a preset fall height. Thus, the radar sensing function is used to detect a recessed zone such as the recess in the floor, thereby preventing the cleaning robot from falling over the recess.

Additional aspects will be set forth in part in the description which follows and, in part, will be apparent from the description, or may be learned by practice of the presented embodiments.

### BRIEF DESCRIPTION OF THE DRAWINGS

The above and other aspects, features, and advantages of particular embodiments of the present disclosure will be more apparent from the following description taken in conjunction with the accompanying drawings, in which:

FIG. 1 illustrates a system including a cleaning robot according to an embodiment;

FIG. 2 is a perspective view of the cleaning robot of FIG. 1 with a sensor;

FIG. 3 is a plan view of the cleaning robot of FIG. 2;

FIG. 4 is a lateral view of the cleaning robot of FIG. 2;

FIG. 5 is a block diagram of a cleaning robot according to an embodiment;

FIGS. 6, 7, and 8, and FIG. 9 part (a) and part (b) are views for explaining a signal pattern for allowing a cleaning robot according to an embodiment to sense various obstacles;

FIG. 10 illustrates a case where the cleaning robot according to an embodiment is positioned in front of a recess;

FIG. 11 is a flowchart of controlling a cleaning robot according to an embodiment; and

FIGS. 12 and 13 are views for explaining a travel control taking an obstacle into account.

### DETAILED DESCRIPTION

Below, embodiments of the present disclosure will be described in detail with reference to accompanying drawings. In the following descriptions of the embodiments with matters illustrated in the accompanying drawings, like numerals or symbols refer to like elements having substantially the same functions.

In the present disclosure, at least one among a plurality of elements refers to not only all the plurality of elements but also both each one of the plurality of elements excluding the other elements and a combination thereof.

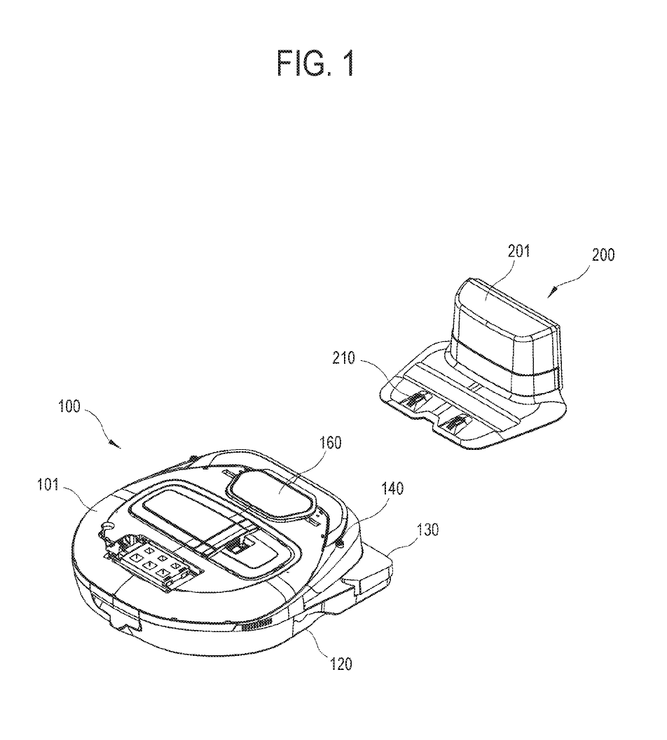

FIG. 1 illustrates a system including a cleaning robot according to an embodiment;

As shown in FIG. 1, a system includes a moving apparatus autonomously moving and performing an operation, and an auxiliary apparatus separated from the moving apparatus, installed at a predetermined stationary location, and assisting the moving apparatus in the operation.

In FIG. 1, the moving apparatus refers to a moving apparatus for cleaning, i.e. a cleaning robot 100, which autonomously moves and cleans a floor within an area of a predetermined range, and the auxiliary apparatus refers to a charging apparatus 200 provided as a charging station (hereinafter, referred to as a docking station or a base station), which charges a battery of the cleaning robot 100. However, there are no limits to each scheme for embodying the moving apparatus and the auxiliary apparatus to which the concept of the present disclosure is applied, and various kinds of apparatuses as well as the cleaning robot 100 and the charging apparatus 200 may be implemented as the moving apparatus or the auxiliary apparatus.

In an embodiment, the cleaning robot 100 includes a camera 140 with an imaging sensor, and is thus implemented by an autonomous driving apparatus which recognizes its own position and moves to a destination along a predetermined path. For example, the cleaning robot 100 may be a dry-type cleaner configured to draw in not a liquid material but dust or foreign materials.

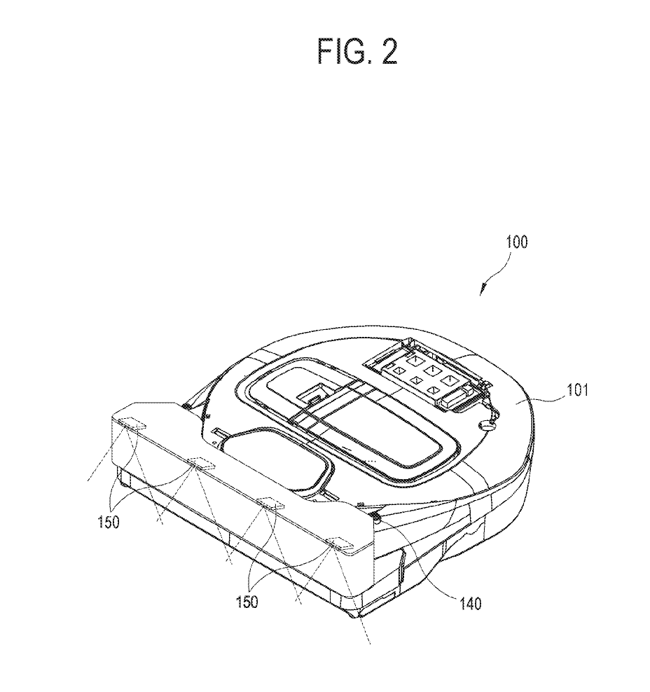

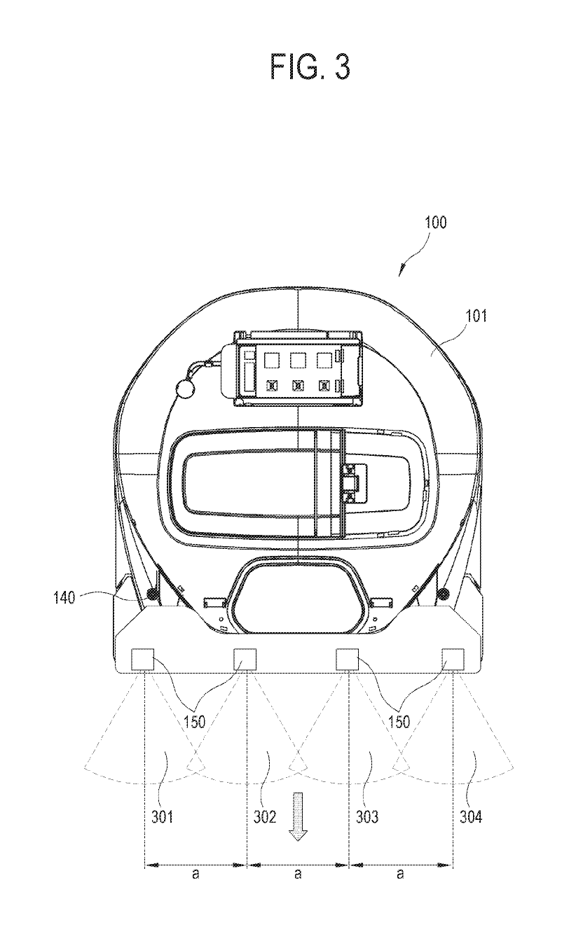

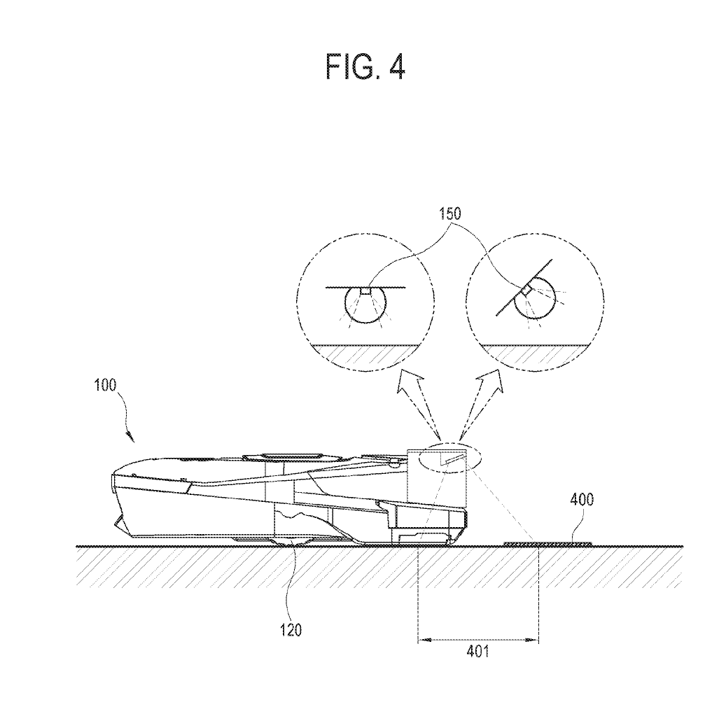

FIG. 2 is a perspective view of the cleaning robot of FIG. 1 with a sensor, FIG. 3 is a plan view of the cleaning robot of FIG. 2, and FIG. 4 is a lateral view of the cleaning robot of FIG. 2.

The cleaning robot 100 as shown in FIGS. 1 to 4 includes a main body 101 forming an outer appearance and installed with general elements, a traveler 120 moving the cleaning robot 100 in a predetermined direction, a cleaner 130 cleaning a floor as the cleaning robot 100 moves, the camera 140 capturing an image of an environment around the cleaning robot 100, and a detector 150 transmitting a radio frequency (RF) signal frontward and detecting a reflected signal. The foregoing elements are some elements, which are provided outside the main body 101, among all the elements of the cleaning robot 100.

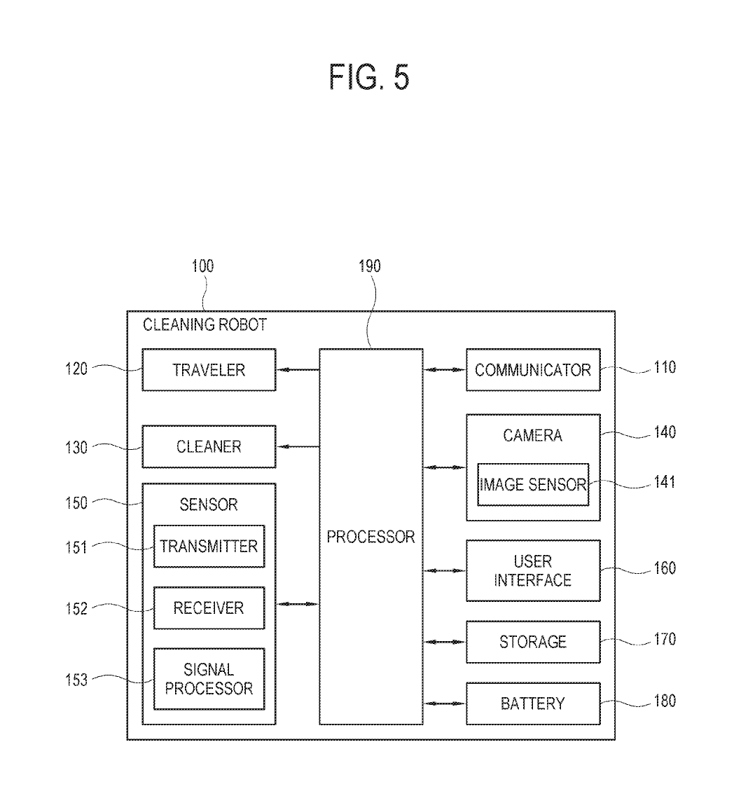

Driving power for the general operations of the cleaning robot 100 such as the traveler 120 and the cleaner 130 is given by a built-in battery (see ‘180’ in FIG. 5) of the main body 101, and the cleaning robot 100 is provided with a charging terminal for charging the battery 180.

To move the cleaning robot 100, the traveler 120 includes one or more wheels to be in contact with on a floor, a motor used as a driver for generating the driving power for the movement, and a link and shaft structure for transferring the driving power of the motor to the wheels.

The traveler 120 includes a plurality of wheels, which are individually driven, so that the cleaning robot 100 can have various movements such as a forward movement, a backward movement, a turning movement, a stationary movement, etc. The moving direction and speed of the cleaning robot 100, caused by the traveler 120, are determined by a control signal transmitted from a processor (see ‘190’ in FIG. 5) in the cleaning robot 100 to the motor.

In an embodiment, the traveler 120 may further include a steering device for physically changing each angle of a plurality of wheels in response to a control signal of the processor 190.

In an alternative embodiment, each number of revolutions of the plurality of wheels in the traveler 120 may be controlled in response to a control signal of the processor 190, so that the moving cleaning robot 100 can be subjected to traveling direction control, i.e. steered.

The cleaner 130 includes a brush for sweeping foreign materials such as dust or the like on a floor, a suction module for drawing in the swept foreign materials, a storage tank for storing the suctioned foreign materials, etc. The cleaner 130 operates to clean a floor while the cleaning robot 100 is moving or remains stationary by the traveler 120.

The camera 140 generates an image by taking or capturing the image of the surroundings of the cleaning robot 100.

There are no limits to places where the camera 140 is installed in the main body 101, and the camera 140 according to an embodiment is installed at a front or upper portion of the main body 101 to capture a forward side of the cleaning robot 100, i.e. a moving direction in which the cleaning robot 100 moves. In an embodiment, the cleaning robot 100 may include a plurality of cameras.

The camera 140 includes a lens through which light passes, and an image sensor (see ‘141’ in FIG. 5). The image sensor 141, to which a complementary metal-oxide semiconductor (CMOS) sensor or a charge coupled device (CCD) sensor may be applied, captures in area in front of the cleaning robot 100 and generates a digital image based on captured results.

According to an embodiment, the camera 140 may be mounted with various kinds of optical lenses to capture a surrounding image in a wider range or more precisely.

The sensor 150 transmits an RF signal toward a floor in front of the cleaning robot 100, and receives a reflection signal of the RF signal.

In the cleaning robot 100 according to an embodiment, the sensor 150 includes a radar module (hereinafter, also referred to as a radar sensor). The radar module includes a transmitter (Tx) (see ‘151’ in FIG. 5) for transmitting the RF signal, and a receiver (Rx) (see ‘152’ in FIG. 5) for receiving the reflection signal. The transmitter 151 and the receiver 152 may be implemented by a transmitting antenna and a receiving antenna, respectively.

In an embodiment, the sensor 150 further includes a signal processor (see ‘153’ in FIG. 5). The signal processor 153 may be implemented by a control circuit for performing at least one among amplification, rectification and modulation with regard to a signal received in the receiver 152.

The RF signal output from the sensor 150 may have a spectrum in the form of distributing energy throughout a wide frequency band without limitations to the frequency band. In an embodiment, the RF signal may be an ultra-wideband (UWB) signal to minimize interference with other signals having a relatively narrow band (e.g. from a global positioning system (GPS), Bluetooth, ZigBee, WLAN, etc.).

In an embodiment, the sensor 150 is installed on the front or top of the main body 101 to detect an obstacle positioned in a traveling direction of the cleaning robot 100. In an embodiment, there may be a plurality of sensors 150.

Specifically, the cleaning robot 100 according to an embodiment may include a plurality of (e.g. four) sensors 150 arranged on the front and top of the main body 101 as shown in FIGS. 2 to 4.

In the cleaning robot 100 according to an embodiment, as shown in FIGS. 2 and 3, the plurality of sensors 150 are arranged in a row at regular intervals “a” to thereby cover the front side of the cleaning robot 100. Here, the arrangement interval “a” may be a preset value so that areas 301-304, i.e. fields of view (FOV) covered by the plurality of sensors 150 can be at least partially overlapped, thereby eliminating an undetected area in front of the cleaning robot 100.

In the cleaning robot 100 according to an embodiment, the sensor 150 is installed as shown in FIG. 4 to have a preset orientation angle to a floor in front of the cleaning robot 100.

In one embodiment, the sensor 150 may be installed to directly face the floor, i.e. to have an orientation angle of 90 degrees to the floor.

In an alternative embodiment, the sensor 150 may be installed to obliquely face the floor, for example, to have an orientation angle of 70 degrees or higher but lower than 90 degrees as a preset angle range to the floor. When the sensor 150 is installed to obliquely face the floor, the areas 301-304, 401 to be covered by the sensor 150 may be more expanded in a forward direction of the cleaning robot 100 than those of when the sensor 150 is installed to have the orientation angle of 90 degrees.

In an embodiment, the sensor 150 may be installed to have an orientation angle, which is adjustable within a preset angle range, e.g. between 70 and 90 degrees in the main body 101.

In an alternative embodiment, the sensor 150 may be installed to be autonomously movable in the main body 101.

In the cleaning robot 100 according to an embodiment, the plurality of sensors 150 may transmit RF signals in sequence, and sequentially receive the corresponding reflection signals.

Additionally, the cleaning robot may further include various elements, such as a user interface (see ‘160’ in FIG. 5) installed in the main body 101, receiving a user's input, and displaying status information of the cleaning robot 100, for example.

According to an embodiment, the user interface 160 may include an input button structure such as a power button for turning on and off the cleaning robot 100, a toggle button for starting and stopping the operation of the cleaning robot 100, a returning button for returning the cleaning robot 100 to the charging apparatus 200, etc. and a display for displaying a current state of the cleaning robot 100 and a state corresponding to a user's instruction.

The charging apparatus 200 is installed at a particular stationary location within a use environment of the cleaning robot 100, and connected to an external power source. The charging apparatus 200 charges the battery of the cleaning robot 100 when the cleaning robot 100 is docked thereon, and additionally performs various maintenance operations of the cleaning robot 100.

The charging apparatus 200 as shown in FIG. 1 includes a main body 201 forming an outer appearance and provided with general elements, and a charging connector 210 connectable with a charging terminal provided in the cleaning robot 100.

In addition, the charging apparatus 200 may further include various elements, for example, a power control circuit internally provided to convert external power (alternating current, AC) into charging power (direct current, DC) and supply the charging power (DC) to the battery 180 of the cleaning robot 100 through the charging connector 210.

With this configuration, the cleaning robot 100 according to an embodiment determines a forward floor state based on a signal pattern detected from the RF signal, i.e. the reflection signal received in the sensor 150, and controls operations of the cleaning robot 100 in accordance with determination results. Here, the floor state includes information about whether an obstacle 400 is present in a forward side, the kind of obstacle, the position of the obstacle, etc. Further, the obstacle 400 includes at least one among a line on which the material of the floor is changed in quality such as liquid and carpet, and a recessed zone such as a recess.

Below, the internal elements of the cleaning robot 100 will be described.

FIG. 5 is a block diagram of a cleaning robot according to an embodiment.

As shown in FIG. 5, the cleaning robot 100 includes a communicator 110, a traveler 120, a cleaner 130, a camera 140, a sensor 150, a user interface 160, a storage 170, a battery 180, and a processor 190.

The traveler 120, the cleaner 130, the camera 140, the sensor 150, and the user interface 160 are equivalent to those described above in relation to the embodiment of FIG. 1.

The communicator 110 includes a communication circuit, a communication chip or the like hardware to perform wireless communication with an external apparatus, for example, the charging station 200 through various wireless protocols. In accordance with the protocols supported in the communicator 110, communication with a server may be performed through a wide area network (WAN) by accessing a communication relay such as an access point. For example, the communicator 110 may support various wireless communication protocols such as Wi-Fi, Bluetooth, Infrared, radio frequency (RF), ZigBee, Wi-Fi direct, etc.

The storage 170 is configured to store or load data. The storage 170 includes a nonvolatile memory in which data is retained regardless of whether system power is supplied or not, and a volatile memory in which data, e.g. a control program to be processed by the processor 190 is temporarily loaded. The nonvolatile memory includes a flash memory, erasable and programmable read only memory (EPROM), a hard disk drive (HDD), a solid state drive (SSD), a read only memory (ROM), etc. The volatile memory includes a random access memory (RAM), a buffer, etc.

The storage 170 is configured to store various pieces of information to be referenced by the processor 190 for the operations of the cleaning robot 100, for example, the travel control according to the determined floor state, the kind of obstacle 400, and the position (distance) of the obstacle 400.

Specifically, for example, information about the pattern of the reflection signal for determining the obstacle may be stored as a lookup table (LUT) in the storage 170. In addition, the storage 170 may be configured to further store data, e.g. a control program, an application, an algorithm, etc. in relation to cleaning, charging, traveling, and the like operations of the cleaning robot 100.

The battery 180 for supplying power to operate the cleaning robot 100 is provided to be rechargeable when internal power is exhausted, so that it can be used again. The battery 180 supplies power of a preset voltage to the elements of the cleaning robot 100 in response to a control signal from the processor 190. The battery 180 has a terminal via which power from the charging connector 210 of the charging station 200 is transferred to the battery 180 while the cleaning robot 100 is being docked on the charging station 200.

In an embodiment, the battery 180 may be provided with a sensor for sensing remaining power, and thus the processor 190 checks information about the remaining power of the battery.

The processor 190 controls operations of the traveler 120 or the cleaner 130, based on at least one of capture results of the camera 140, a pattern of a signal received in the sensor 150, and an input of the user interface 160.

The processor 190 refers to a circuit implemented by combination of a central processing unit (CPU), a chipset and a microcontroller, or by a system on chip (SoC). The processor 190 performs computing and directing operations for general operations to be performed by the cleaning robot 100 in accordance with a control program.

The control program may include a program(s) achieved by a basic input/output system (BIOS), a device driver, an operating system, a firmware, a platform, and an application. According to an embodiment, the application may be previously installed or stored when the cleaning robot 100 is manufactured, or may be installed in the cleaning robot 100 based on application data received from the outside when required in the future. The application data may, for example, be downloaded from an application market and the like external server to the cleaning robot 100. Such an external server is one example of a computer program product according to the present disclosure, but the present disclosure is not limited thereto.

Below, an embodiment of determining a floor state, such as presence of an obstacle, the kind of the obstacle, or the position of the obstacle, based on the pattern of the signal received through the sensor 150 will be described.

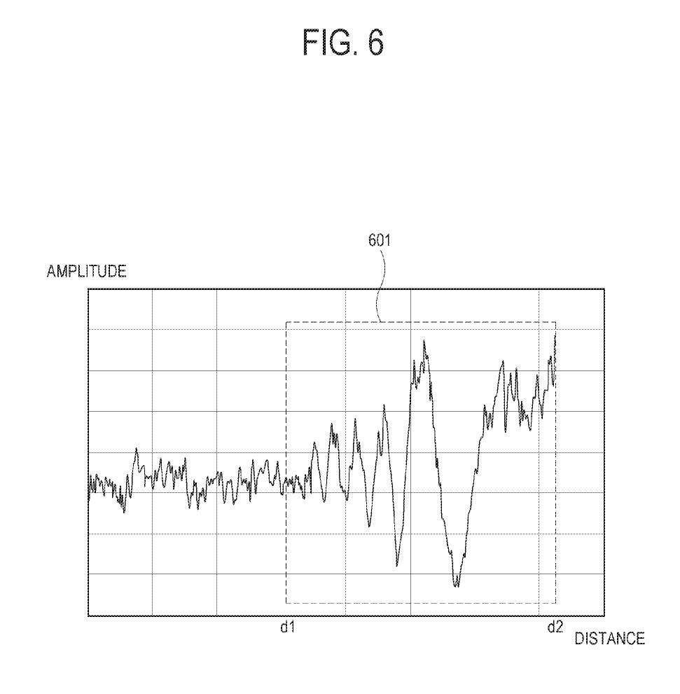

FIGS. 6 to 9 are views for explaining a signal pattern for allowing a cleaning robot according to an embodiment to sense various obstacles.

The RF signal refers to a signal having a particular period. The RF signal is transmitted from the transmitter 151, travels in all directions or one direction, is reflected from a floor, an obstacle or the like object, and is received in, i.e. incident to, the receiver 152 as the reflection signal. When the RF signal meets an obstacle, a part of the RF signal may be reflected from the obstacle, and the other part may penetrate the obstacle.

Such an RF reflection signal tends to increase in irregularity, amplitude, or intensity as an object is more reflective. Further, the RF reflection signal is varied in a signal pattern depending on the kind, size, and surface characteristics of object targeted for reflection. For example, the reflection signal is largely affected by a medium characteristic, i.e. a material constant (ε) of an object. When the object is liquid, water has a material constant (ε) of ‘11’, alcohol has a material constant (ε) of ‘5’. On the other hand, when the object is wood for the floor, its material constant (ε) is ‘2’.

According to an embodiment, a reflection area of an RF signal, i.e. a radar cross-section is affected by 1/√ε. Therefore, a reflection signal from a floor made of wood without the obstacle and a reflection signal from water, alcohol and other liquids are different in the signal pattern from each other.

For example, when a liquid obstacle is present at a predetermined distance of ‘d1’ from the front of the cleaning robot 100, as shown in FIG. 6, a reflection signal 601 received at a distance beyond ‘d1’ is irregularly increased in amplitude and has a signal pattern in which amplitude and period of a phase are varied.

In the cleaning robot 100 according to an embodiment, the reflection signal received through the receiver 152 of the sensor 150 has a signal pattern showing change in amplitude or phase greater than or equal to a preset value, the processor 190 recognizes that the liquid is present as the obstacle at a position where the change is made, for example, at the distance (i.e. horizontal distance) of ‘d1’ from the front of the cleaning robot 100 (see FIG. 6). Here, a first reference value (i.e. threshold) for determining the change in the amplitude or phase may be previously stored in the storage 180.

In an embodiment, the processor 190 determines change in either of the amplitude or the phase based on the signal pattern of the reflection signal, and recognizes the presence of the liquid based on the determination results. According to an alternative embodiment, the processor 190 may determine change in both the amplitude and the phase based on the signal pattern of the reflection signal, and recognizes the presence of the liquid based on the determination results.

Here, the processor 190 may determine the horizontal distance of ‘d1’ between the cleaning robot 100 and the obstacle 400 based on information about time taken from the transmission of the RF signal to the reception of the reflection signal of which change in amplitude or phase is greater than or equal to a preset value. That is, the processor 190 may measure a difference in time (i.e. time of fight (TOF)) between the transmission of the RF signal and the reception of the reflection signal, and use the TOF in determining the horizontal distance.

In an embodiment, the processor 190 calculates the horizontal distance between the cleaning robot 100 and the obstacle 400, based on a transmission speed of the RF signal, the TOF until the reflection signal of which change is amplitude or phase is greater than or equal to a preset value is received from the transmission of the RF signal, etc. For example, the horizontal distance of ‘d1’ between the cleaning robot 100 and the obstacle 400 may be obtained by dividing the product of the TOF of the reflection signal and the speed of the RF signal by ‘2’.

In an alternative embodiment, the storage 180 may be configured to store information about the horizontal distance corresponding to the TOF between the transmission of the RF signal and the reception of the reflection signal, in which the horizontal distance may be varied depending on not only the transmission speed of the RF signal, but also an installation angle, i.e. an inclination of the sensor 150. In this case, the processor 190 determines the TOF between the transmission of the RF signal and the reception of the reflection signal, and loads the horizontal distance corresponding to the determined TOF from the storage 180.

According to the foregoing embodiments, the cleaning robot 100 is configured to detect a distance between the cleaning robot 100 and the obstacle 400 based on information about time taken from the transmission of the RF signal to the reception of the reflection signal, but the present disclosure is not limited thereto. Alternatively, the cleaning robot 100 may detect the horizontal distance from the obstacle 400 based on the amount of energy the reflection signal has. In other words, the horizontal distance may be detected on the principle that the amount of energy a received reflection signal has decreases in proportion to the traveling distance of the reflection signal.

In an embodiment, the processor 190 may determine an obstacle by acquiring a plurality of reflection signals through the sensor 150.

For example, the processor 190 gathers the reflection signals for a predetermined time, i.e. a particular period, and determines whether liquid or the like obstacle is present based on a signal pattern detected from the gathered reflection signals. Here, the processor 190 averages the gathered reflection signals, and applies additional processes to the averaged reflection signals. Here, the processes may include calculation for obtaining predetermined characteristics (e.g. a frequency, a phase, an amplitude, etc.) of the signal, noise removal, etc.

Alternatively, the processor 190 may average the reflection signals received from a plurality of sensors 150, and applies additional processes to the averaged reflection signals. Here, the processes may include calculation for obtaining predetermined features (e.g. a frequency, a phase, an amplitude, etc.) of the signal, noise removal, etc.

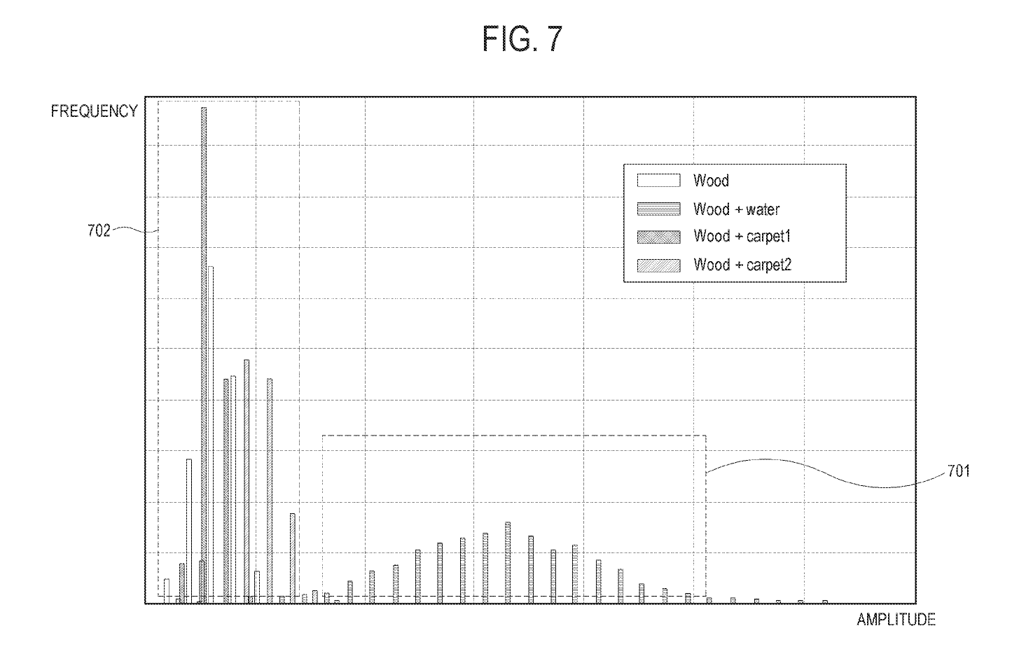

FIG. 7 shows a signal obtained by averaging and processing a plurality of reflection signals.

As shown in FIG. 7, when the obstacle 400 such as liquid or a carpet is present on a floor in front of the cleaning robot 100, the reflection signal may have a signal pattern in which not only the amplitude, but also other characteristics such as the frequency, the phase, etc. are changed.

Referring to FIG. 7, when water is present on a wooden floor, amplitudes of reflection signals 701 are generally distributed corresponding to higher level as compared with those of the reflection signals of the other floors. Therefore, as shown in FIG. 6, when the signal pattern of the reflection signal shows a change in amplitude or phase greater than or equal to a preset value, the processor 190 determines that liquid is present as an obstacle at a position (i.e. point) where the change is made.

Further, referring to FIG. 7, the reflection signals 701 received when water is present on the floor show generally lower frequency characteristics than the reflection signals of the other floors. Therefore, when the signal pattern of the reflection signal shows a low frequency while a change in amplitude thereof is greater than or equal to a preset value, the processor 190 determines that liquid is present as an obstacle at a point where the change is made. Thus, not only the amplitude and the phase, but also the frequency characteristics of the reflection signal are taken into account to determine the presence of the liquid, thereby improving accuracy in detecting the obstacle.

Further, as shown in FIG. 7, reflection signals 702 processed when various carpets (e.g. carpet1 and carpet2) are present on the floor show generally higher frequencies than the reflection signals of the other floors. In an embodiment, the processor 190 determines that a carpet is present as an obstacle at a point where the frequency increases, when the signal pattern of the reflection signal shows that the frequency increases to be higher than or equal to a preset value.

Further, as shown in FIG. 7, the reflection signals 702 processed when various carpets (e.g. carpet1 and carpet2) are present on the floor show generally lower amplitudes than the reflection signals of the other floors. Therefore, when the signal pattern of the reflection signal is relatively decreased in amplitude while the frequency thereof is higher than a preset value, the processor 190 determines that the carpet is present as an obstacle at a point where the change is made. Thus, not only the amplitude, but also the frequency characteristics of the reflection signal are taken into account to determine the presence of the carpet, thereby improving accuracy in detecting the obstacle.

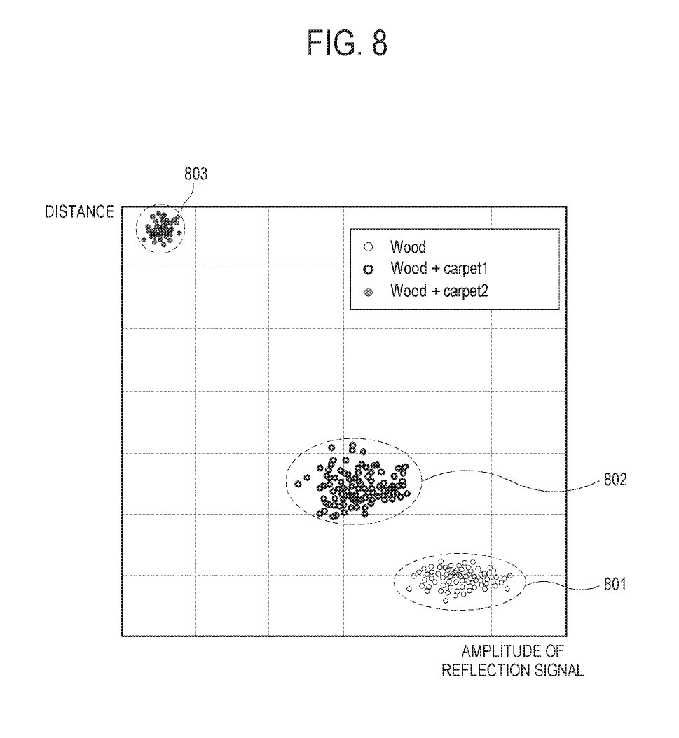

FIG. 8 illustrates signal patterns of reflection signals according to states of a floor, in which the reflection signals are different in signal pattern according to a case 801 where the floor is made of a hard material such as wood, and cases 802 and 803 where soft carpets are laid on the wooden floor.

Specifically, a surface of a soft carpet is irregular and uneven as compared with that of a hard floor, and therefore causes relatively greater diffused reflection of an RF signal. Thus, a ratio of a reflection signal to an RF signal, i.e. reflectivity on the surface where the carpet is laid is relatively low.

In other words, when a carpet with low reflectivity is laid on the floor, difference in intensity between the reflection signal received in the receiver 152 and the RF signal transmitted by the transmitter 151 is so large that the amplitude, i.e. the intensity of the reflection signal is relatively low in the cases 802 and 803 of the floor as shown in FIG. 8.

Accordingly, in an embodiment, the processor 190 determines the state of the floor, i.e. the quality of the material on the basis of the intensity of the reflection signal, thereby recognizing the carpet as the obstacle where the floor is changed in the quality of the material. For example, the processor 190 may determine a line between two floors different in quality of a material, for example, a boundary between a wooden floor with no carpets and a wooden floor on which a carpet is laid, based on a point where the amplitude of the reflection signal is lower than a preset value. Alternatively, the processor 190 may determine a boundary between two floors different in quality of a material, based on a point where reflectivity corresponding to comparison between the amplitude of the reflection signal received in the receiver 152 and the amplitude of the RF signal transmitted by the transmitter 151 is lower than a preset value.

Meanwhile, when the carpet is laid on the floor, the RF signal is partially reflected from the surface of the carpet and partially reflected from the floor while penetrating the carpet. The cleaning robot 100 according to an embodiment may recognize the carpet as the obstacle where the floor is changed in quality of a material, based on a time interval, i.e. a time gap between the reflection signal from the carpet and the reflection signal from the floor.

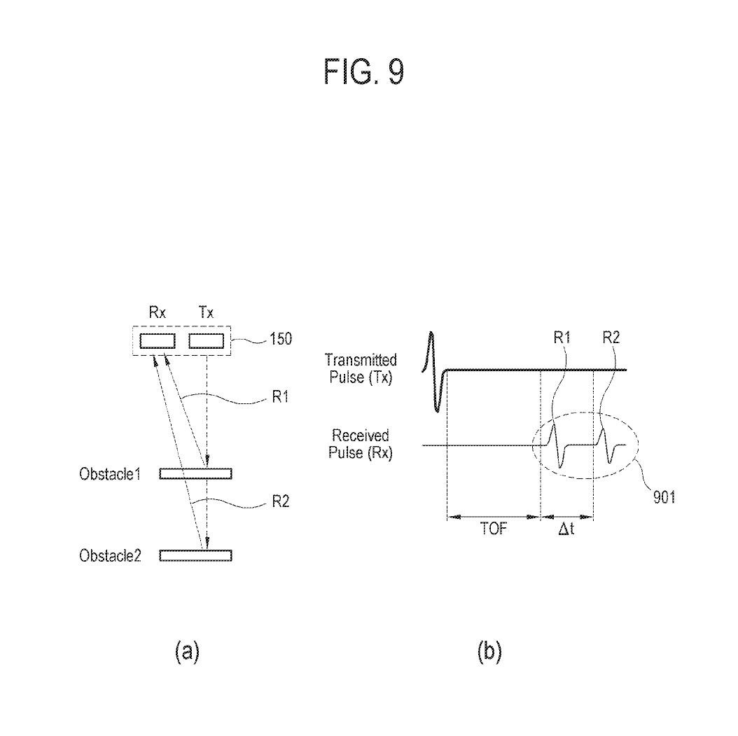

Specifically, when it is assumed that the sensor 150 has an orientation angle of 90 degrees to a floor and a carpet is laid on the floor, an obstacle1 corresponds to the carpet, and an obstacle2 corresponds to the floor as shown in part (a) of FIG. 9.

The RF signal output from the transmitter Tx or 151 of the sensor 150 is partially received as a first pulse R1 due to the carpet (i.e. obstacle1) in the receiver Rx or 152, and then partially received as a second pulse R2 due to the floor (i.e. obstacle2) in the receiver Rx after a predetermined time elapses.

Therefore, as shown in part (b) of FIG. 9, the received reflection signal 901 (i.e. receiver pulses) includes a plurality of pulses R1 and R2 with signal patterns generated leaving a particular time interval (Δt) in between. Here, the time interval (Δt) between the plurality of pulses R1 and R2 corresponds to a vertical distance between the surface of the carpet (i.e. obstacle1) and the surface of the floor (i.e. obstacle2), that is, the thickness of the carpet (i.e. obstacle1).

In an embodiment, when the signal pattern of the reflection signal includes a plurality of pulses generated leaving an interval shorter than a second reference value corresponding to a preset time, the processor 190 recognizes a carpet as an obstacle where a floor is changed in quality of a material. Here, the second reference value is determined as a value covering the thickness of a typical carpet, and may be calculated as a value obtained by dividing a distance slightly greater than the thickness of the carpet (for example, 1 cm) by the speed of the RF signal. That is, the thickness of the carpet is generally not greater than 1 cm, the processor 190 determines the presence of the obstacle as the carpet laid on the floor when a plurality of pulses is generated leaving a time interval corresponding to not greater than 1 cm.

Here, the processor 190 may determine that a line between two floors different in quality of a material (e.g. a general floor with no carpets and a floor with a carpet) is present in front of the cleaning robot, on the basis of a position where the first pulse is generated. For example, a line where the carpet is laid may be determined based on a distance corresponding to a value obtained by multiplying time, which is taken until the first pulse is received, by the RF signal and then dividing it by 2.

In an embodiment, the processor 190 may further employ information about the intensity of the signal described with reference to FIG. 8 in order to determine the presence of the carpet. That is, the processor 190 determines a line between two floors different in quality of a material, i.e. a line of the carpet on the basis of a position where the intensity of the reflection signal is lowered, when the signal pattern of the reflection signal includes a plurality of pulses generated leaving an interval shorter than a preset time while having an amplitude (or intensity) lower than a preset reference value.

The foregoing description illustrates an example of determining the presence of the carpet in a case where the sensor 150 is installed to have an orientation angle of 90 degrees, but the present disclosure is not limited thereto. That is, even when the sensor 150 is installed to obliquely face the floor as shown in FIG. 4, the obstacle is determined as the carpet laid on the floor as long as the signal pattern of the received reflection signal includes a plurality of pulses R1 and R2 generated leaving a particular time interval (Δt) in between. In this case, the time interval (Δt) between the plurality of pulses R1 and R2 is determined by considering not only the vertical distance between the surface of the floor and the surface of the carpet, but also the installation angle of the sensor 150, and may be stored in the storage 180.

Meanwhile, the cleaning robot 100 according to an embodiment is configured to further sense a recess of the floor by using the RF signal and its reflection signal.

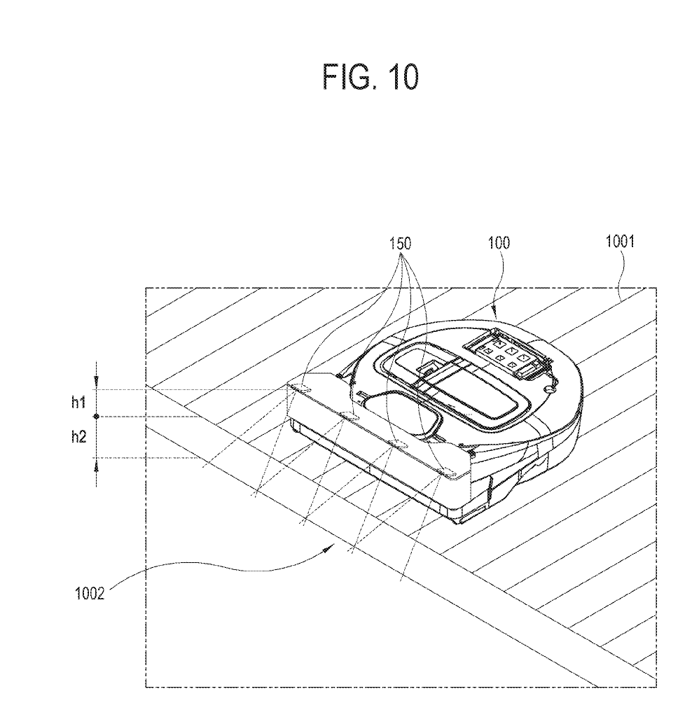

FIG. 10 illustrates a case where the cleaning robot according to an embodiment is positioned in front of a recess.

As shown in FIG. 10, the cleaning robot 100 may reach a recess 1002, i.e. a boundary of a recessed zone 1002, which is suddenly lower than the floor like a stair, while traveling on a floor 1001.

In this case, when it is assumed that the sensor 150 has an orientation angle of 90 degrees to the floor, the obstacle1 and the obstacle2 in (a) of FIG. 9 respectively correspond to the floor 1001 and the recessed zone 1002.

The processor 190 detects a distance (i.e. vertical distance) from the floor based on the TOF between the transmission of the RF signal and the reception of the reflection signal, and determines that the recess 1002 is present in front of the cleaning robot 100 when the vertical distance from the floor is changed to be longer than or equal to a preset reference distance. Here, a third reference value for determining whether the vertical distance is longer than or equal to the reference distance may be determined to correspond to a sum of a height h1 between the floor and the sensor 150 installed in the cleaning robot 100 and a height h2′ by which the cleaning robot 100 is expected to fall from the recess 1002. The fall height h2′ is determined based on the depth of the recessed zone 1002 shown in FIG. 10, for example, a height h2 of a stair. For example, when the stair typically has a height of 16-20 cm, it may be determined that the fall height h2′ is about 12 cm.

The foregoing embodiment shows an example of determining the recess when the sensor 150 is installed to have the orientation angle of 90 degree to the floor, but the present disclosure is not limited thereto. Alternatively, in even a case where the sensor 150 is installed to obliquely face the floor as shown in FIG. 4, it is possible to determine that the recess 1002 is present in front of the cleaning robot 100 when the vertical distance from the floor, obtained based on the TOF between the transmission of the RF signal and the reception of the reflection signal, is longer than or equal to the reference distance. In this case, time taken until the reflection signal is received may be stored in the storage 180 as a preset value obtained by considering not only the height h1 of the sensor 150 and the expected fall height h2′ due to the recess 1002, but also the installation angle of the sensor 150.

As described above, the cleaning robot 100 according to an embodiment determines whether at least one of liquid, a carpet, and a recess is present as an obstacle on a forward floor, based on various signal patterns detected from a reflection signal of an RF signal, and is then controlled to avoid the obstacle or change an operation mode according to determination results.

Below, a method of controlling a cleaning robot according to an embodiment will be described with reference to accompanying drawings.

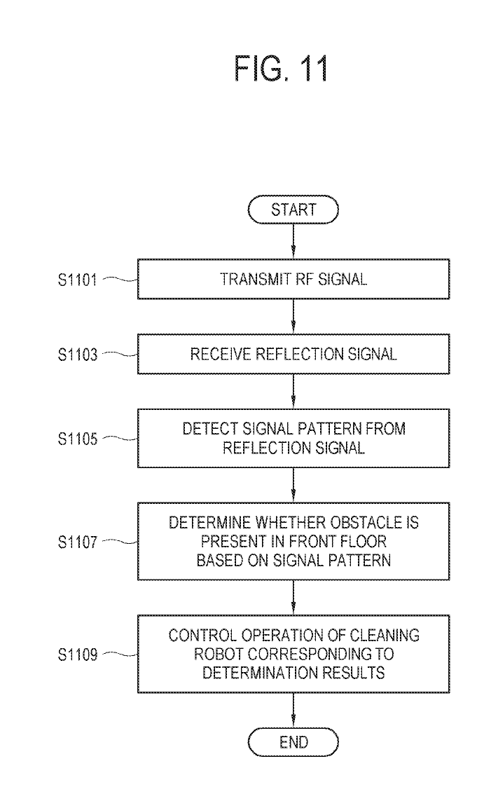

FIG. 11 is a flowchart of controlling a cleaning robot according to an embodiment.

As shown in FIG. 11, the transmitter 151 of the sensor 150 in the cleaning robot 100 according to an embodiment transmits an RF signal toward a front floor (operation S1101)

The processor 190 receives a reflection signal, which is caused by the RF signal transmitted in the operation S1101, through the receiver 152 of the sensor 150 (operation S1103). In the operations S1101 and S1103, the processor 190 may transmit RF signals in sequence from the plurality of sensors 150, and then sequentially receive the reflection signals.

The processor 190 detects a signal pattern from the reflection signal received in the operation S1103 (operation S1105). Here, the processor 190 may calculate various values such as distance information, amplitude, etc. from the reflection signal, to thereby detecting the signal pattern.

The processor 190 determines whether an obstacle is present in the floor on the basis of the signal pattern detected in the operation S1105 (operation S1107). For example, when the signal pattern shows that change in amplitude or phase is greater than or equal to a preset value as shown in FIG. 6, the processor 190 may determine that liquid is present in front of the cleaning robot 100 as an obstacle at a position (distance) where the change in amplitude is made. Here, the processor 190 may determine a horizontal distance between the cleaning robot 100 and the obstacle 400 based on information about time taken from the transmission of the RF signal to the reception of the reflection signal. Alternatively, when the signal pattern includes a plurality of pulses generated leaving an interval shorter than a preset time as described with FIG. 9, the processor 190 may determine that a carpet, i.e. a line between two floors different in quality of a material (e.g., a general floor with no carpets and a floor with a carpet) is present as an obstacle in front of the cleaning robot 100. Alternatively, when the signal pattern shows that a vertical distance from the floor is longer than or equal to a reference distance as shown in FIG. 10, the processor 190 determines that a recess is present as an obstacle at a position where the vertical distance is changed (increased) in front of the cleaning robot 100. The method of detecting the presence of the obstacle and the kind of obstacle in the operation S1107 is not limited to the foregoing examples, and may be achieved by various embodiments described in relation to FIGS. 6 to 10 or combination of the embodiments.

Further, the operations of the cleaning robot 100 are controlled in accordance with the determination results in the operation S1107 (operation S1109). Here, the cleaning robot 100 may be controlled to travel avoiding the obstacle 400 in accordance with the kind, position, etc. of the detected obstacle. Further, the processor 190 may provide an alarm warning, voice notification, etc. according to the detection results.

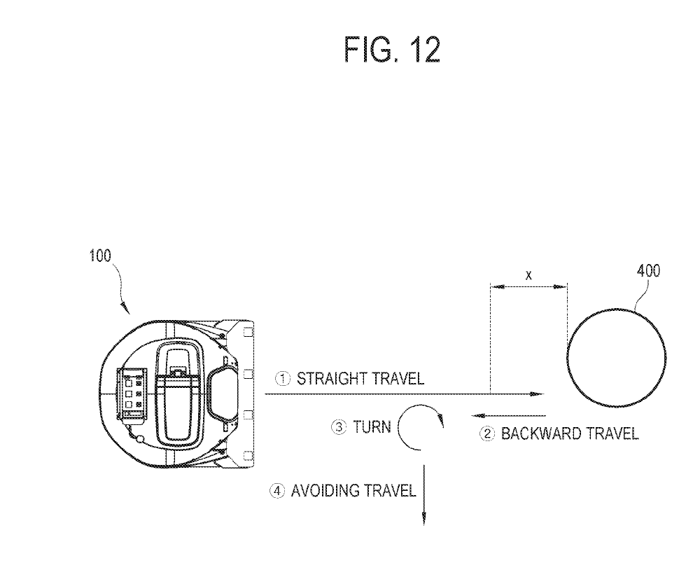

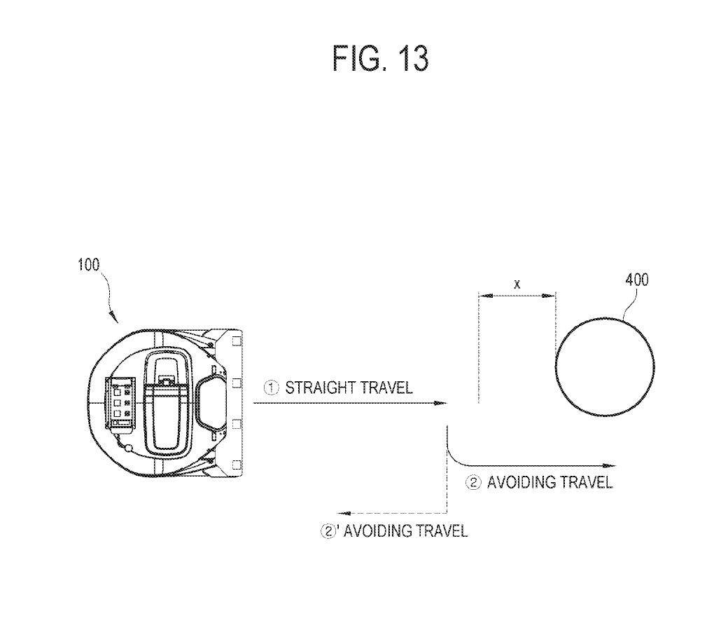

FIGS. 12 and 13 are views for explaining a travel control taking an obstacle into account.

In an embodiment, in a state that the cleaning robot 100 is positioned at a distance from an obstacle 400 closer than a reference distance of ‘X’, the processor 190 may detect the obstacle 400.

As shown in FIG. 12, the cleaning robot 100 may recognize the obstacle 400 present at a position within the reference distance of ‘X’ while straightly traveling (1) toward the obstacle 400 to perform cleaning. When it is determined in the operation S1107 that the obstacle 400 is liquid or a recess, the processor 190 controls the traveler 120 to travel backward (2), turn (3), and avoid (4) the obstacle 400 because it is difficult for the cleaning robot 100 to immediately avoid the obstacle 400.

On the other hand, as shown in FIG. 13, the cleaning robot 100 may recognize the obstacle 400 present at a position beyond the reference distance of ‘X’ while (1) straightly traveling toward the obstacle 400 to perform cleaning. When it is determined in the operation S1107 that the obstacle 400 is liquid or a recess, the processor 190 controls the traveler 120 so that the cleaning robot 100 can travel while avoiding the obstacle 400. Here, when the recognized obstacle 400 is liquid, the cleaning robot 100 may travel along an avoiding path (2). Further, when the recognized obstacle 400 is a recess, the cleaning robot 100 may travel along an avoiding path (2)′, and thus be prevented from falling.

Meanwhile, when it is determined in the operation S1107 that the obstacle 400 is a carpet, the processor 190 controls the outputs of the traveler 120 and the cleaner 130.

Specifically, the processor 190 controls the traveler 120 to make the cleaning robot 100 climb up the carpet. The processor 190 generates a control signal for changing a traveling mode of the cleaning robot 100 into a climbing mode, and transmits the control signal to the traveler 120, thereby increasing a torque of a motor which transmits driving power for movement to wheels. Thus, the cleaning robot 100 easily climbs up the carpet and cleans the carpet.

Here, the processor 190 may further generate a control signal for making the cleaning robot 100 operate in a high-power suction mode. Such a generated control signal is transmitted to the cleaner 130, thereby controlling the cleaning robot 100 to draw in dust or the like with a relatively stronger suction force and thus clean the carpet with a higher efficiency.

According to various embodiments as described above, the cleaning robot 100 includes the sensor 150 for transmitting an RF signal and receiving a reflection signal corresponding to the RF signal, and detects an obstacle such as a liquid, a recess, etc. based on a signal pattern of the reflection signal, thereby traveling while properly avoiding the obstacle.

In addition, the cleaning robot 100 further detects a carpet and similar obstacles based on the signal pattern of the reflection signal, and is then controlled to travel and operate, thereby more efficiently cleaning the carpet and similar material requiring a stronger suction force.

Although a few embodiments have been described in detail, the present disclosure is not limited to these embodiments and various changes may be made without departing from the scope defined in the appended claims.

What is claimed is:

1. A moving apparatus for cleaning, comprising:
a cleaner configured to perform a cleaning operation;
a traveler configured to move the moving apparatus;
a sensor comprising a transmitter configured to transmit a radio frequency (RF) signal toward a surface, and a receiver configured to receive a reflection signal of the transmitted RF signal; and
at least one processor configured to:
detect a signal pattern in the received reflection signal based on a change in at least one of a frequency, a phase, and an amplitude of the received reflection signal,
determine whether an obstacle is present on the surface based on the detected signal pattern, and
control at least one of the traveler and the cleaner based on the determination.

2. The moving apparatus according to claim 1, wherein, when the detected signal pattern shows the change in the at least one of the amplitude and the phase greater than or equal to a predetermined threshold value, the at least one processor determines that the obstacle is a liquid.

3. The moving apparatus according to claim 1, wherein the at least one processor is further configured to control the traveler to move the moving apparatus while avoiding the obstacle based on the determination.

4. The moving apparatus according to claim 1, wherein the at least one processor is further configured to determine a horizontal distance between the moving apparatus and the obstacle based on a time taken from the transmission of the RF signal to the reception of the reflection signal, and control the traveler to move the moving apparatus based on the determined horizontal distance.

5. The moving apparatus according to claim 4, wherein the at least one processor is further configured to control the traveler to move the moving apparatus in a backward direction, turn, and then travel while avoiding the obstacle when the determined horizontal distance is less than a reference distance.

6. The moving apparatus according to claim 1, wherein the at least one processor is further configured to determine a boundary between two floors made of a different material, when the detected signal pattern comprises a plurality of pulses received at an interval less than a preset time.

7. The moving apparatus according to claim 6, wherein, when the detected signal pattern comprises the plurality of pulses, the at least one processor determines that the obstacle is a carpet, and controls the traveler and the cleaner according to the determination that the obstacle is a carpet.

8. The moving apparatus according to claim 1, wherein, when the detected signal pattern indicates that a vertical distance from the moving apparatus to the surface is greater than or equal to a reference distance, the at least one processor determines that a recess zone is present in the surface.

9. The moving apparatus according to claim 8,
wherein the processor is further configured to determine the vertical distance based on a time taken from the transmission of the RF signal to the reception of the reflection signal, and
wherein the reference distance corresponds to a sum of a height of the sensor from the surface and a preset fall height.

10. The moving apparatus according to claim 1, wherein the sensor is installed on the moving apparatus to have a preset orientation angle relative to the surface.

11. The moving apparatus according to claim 10, wherein the sensor is provided as a plurality of sensors, and the plurality of sensors are arranged to have partially overlapping coverage.

12. A method of controlling a moving apparatus for cleaning, the method comprising:
transmitting, by a sensor, a radio frequency (RF) signal toward a surface;
receiving, by the sensor, a reflection signal of the transmitted RF signal; and
performing, by at least one processor, operations comprising:
detecting a signal pattern in the received reflection signal based on a change in at least one of a frequency, a phase, and an amplitude of the received reflection signal;
determining whether an obstacle is present on the surface based on the detected signal pattern; and
controlling at least one of a traveler and a cleaner of the moving apparatus based on the determination.

13. The method according to claim 12, wherein the operations further comprise determining that the obstacle is a liquid, when the detected signal pattern shows the change in the at least one of the amplitude and the phase greater than or equal to a predetermined threshold value.

14. The method according to claim 12, wherein the operations further comprise controlling the moving apparatus to travel while avoiding the obstacle based on the determination.

15. The method according to claim 12, wherein the operations further comprise:
determining a horizontal distance between the moving apparatus and the obstacle based on a time taken from the transmission of the RF signal to the reception of the reflection signal; and
controlling the moving apparatus to travel based on the determined horizontal distance.

16. The method according to claim 15, wherein the controlling the moving apparatus to travel comprises controlling the moving apparatus to travel in a backward direction, turn, and then travel while avoiding the obstacle when the determined horizontal distance is less than a reference distance.

17. The method according to claim 12, wherein the operations further comprise determining a boundary between two floors made of a different material, when the detected signal pattern comprises a plurality of pulses received at an interval less than a preset time.

18. The method according to claim 17, wherein the operations further comprise:
determining that the obstacle is a carpet when the detected signal pattern comprises the plurality of pulses; and
controlling the moving apparatus to travel and clean according to the determination that the obstacle is a carpet.

19. The method according to claim 12, wherein the operations further comprise determining that a recess zone is present in the surface, when the detected signal pattern indicates that a vertical distance from the moving apparatus to the surface is greater than or equal to a reference distance.

20. The method according to claim 19, wherein the operations further comprise determining the vertical distance based on a time taken from the transmission of the RF signal to the reception of the reflection signal, and
wherein the reference distance corresponds to a sum of a height of the sensor from the surface and a preset fall height.
